(19) United States
(12) Patent Application Publication
(10) Pub. No.: US 2011/0006194 A1
(43) Pub. Date: Jan. 13, 2011

(54) METHOD AND DEVICE FOR MEASURING SOLAR IRRADIANCE USING A PHOTOVOLTAIC PANEL

(76) Inventors: Raul Manuel Pereira Morais Dos Santos, Vila Real (PT); Samuel Ricardo Goncalves Matos, Vila Real (PT); Paulo Jonge Dos Santos Goncalves Ferreira, Vila Real (PT); Manuel Jose Cabral Dos Santos Reis, Vila Real (PT)

Correspondence Address: SUGHRUE MION, PLLC, 2100 PENNSYLVANIA AVENUE, N.W., SUITE 800, WASHINGTON, DC, 20037, US

(21) Appl. No.: 12/811,779

(22) PCT Filed: Jan. 5, 2009
(86) PCT No.: PCT/PT09/00001

§ 371 Date: Sep. 27, 2010

(30) Foreign Application Priority Data
Jan. 7, 2008 (PT) PT 103923

(51) Int. Cl. G01J 1/42

(52) U.S. Cl. 250/208.2

(57) ABSTRACT

The present invention relates to a measurement method to determine the magnitude and intensity of solar radiation/collected by a photovoltaic solar panel, without the need of using specific sensors for this purpose—With the present method̂ the power conditioning systems used in small photovoltaic panels to charge small rechargeable batteries, will now be able to provide an electrical signal, in the form of a pulse sequence or in any other electrical signal, that represents the value of the quantity that generates the available energy. The present method enables the monitoring the energy transfer between the solar panel and a rechargeable battery using a switched, voltage converter; additionally it indicates the magnitude of the solar radiation falling on the solar panel. It is based on the adaptation of a direct voltage to direct voltage boost converter circuit in. order to provide an electrical signal which is correlated to the magnitude of the solar irradiance falling on the solar panel, which in turn powers the voltage converter circuit. The invention also relates to a device for implementing this method.

### TECHNICAL DOMAIN OF THE INVENTION

The present invention consists of a method, which by combining a photovoltaic solar panel with a battery's charge controller circuit based on a booster-type voltage converter circuit, enables a signal to be obtained which is proportional to the solar radiation falling on the panel. This methodology will complement the electrical generating function of the solar panel by the sensing function, which is extremely useful in small electrical and electronic devices that can be powered by this energy source.

### REMIT OF THE INVENTION

The present invention is related to power conditioning systems that are used in battery's charging process. More particularly, in most of the cases, this methodology enables the elimination of solar irradiance sensors that may have to be used to measure, somehow, the intensity or magnitude of solar irradiance in devices that employ this method.

This methodology also allows for more efficient mechanisms for charging the batteries of small stationary systems that can be deployed as sensor network nodes applied to the monitoring of any process, which are powered by energy harvested from the surrounding environment.

### BACKGROUND OF THE INVENTION

Solar energy is becoming increasingly important in powering electrical and electronic systems. However, its simultaneous use as a sensor of solar irradiance (source of solar energy that is converted into electrical energy by the solar panel) is not particularly feasible—despite its interest—because the panel's electric model consists of a voltage limited current source. This means that the current supplied by the panel for low irradiance levels is almost independent of the voltage to its terminals, but varies with the intensity of the solar irradiance. For high levels of solar irradiance, the current ceases to be constant and depending only on the solar radiation, and becomes dependent on the voltage of the solar panel's terminals.

This behaviour demonstrates that the measurement of the magnitude of the solar irradiation falling on a small solar panel is not independent of the electrical current that is required from the panel. Making the measurement of this value independent of the electrical current and/or voltage may characterise the panel's operating regime, which may be performed by quantifying the rate of energy transfer between the panel and the rechargeable battery, performed at a constant period.

The applicant is not aware of any previous technique which allows the rate of energy transfer between a panel and a chargeable battery to be measured. There are, however, some documents of previous techniques which are to some extent capable of measuring irradiation. These previous techniques include documents U.S. Pat. No. 4,372,680 and U.S. Pat. No. 6,417,500.

Specifically, U.S. Pat. No. 4,372,680 concerns to a miniature dosimeter, which is spectrally selective and capable of measuring, in small mobile areas, selected bandwidths of irradiation exposure. This is achieved via the combination of photovoltaic detectors, electrochemical integrators (E-type batteries) and filters in a small compact case that can be easily fitted onto the surface to be measured in close proximity to this surface and substantially parallel to it.

U.S. Pat. No. 6,417,500 relates to a solar irradiation sensor, with particular application to sunlight detection, endowed with at least two (but typically seven) light-sensitive detectors and a occultation element. A signal processor analyses the detectors signals; this analysis includes a comparison between the signal, coming from the detector exposed to the greatest luminous intensity and the signal from the detector exposed to the lowest luminous intensity.

The aforementioned documents do not have the same aims and neither do they employ the same technology.

### SUMMARY OF THE INVENTION

The present invention consists of a method to measure the magnitude of solar irradiance falling on a solar panel with the atm of providing sensorial information about this quantity, in the form of an electrical signal.

Specifically, the purpose of the invention consists of a methodology that gives an electrical signal correlated to the magnitude of the incident solar irradiance, to be used in electrical and/or electronic devices powered by small solar panels. This methodology is essentially intended to be used in devices where data on solar irradiance needs to be gathered in any kind of application, as a climatic variable, or to generate any type of action which depends on, the value of the solar irradiance.

### BRIEF DESCRIPTION OF THE DRAWINGS

The following description is based on the annexed drawings, which, without any limited way, represent:

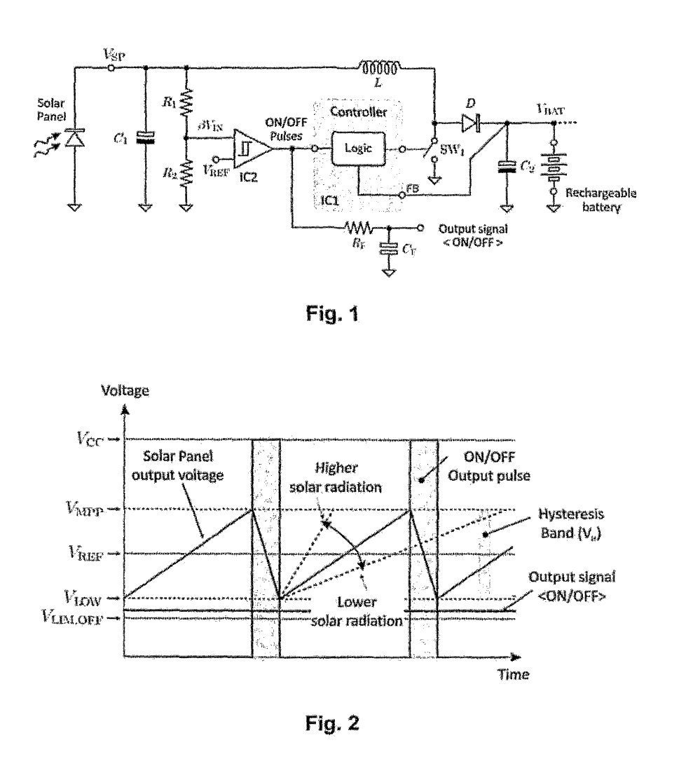

In FIG. 1, a diagram of a battery charging circuit which, schematically, uses a DC-DC converter to boost the low input voltage to a greater voltage value that will correspond to the battery's maximum voltage.

In FIG. 2, a plot of typical wave forms of the circuit represented in FIG. 1 illustrating the employed methodology operating principle. The shadowed ON/OFF area, corresponding to the PULSEOUT signal, depends on whether the amount of incident solar irradiation is greater or smaller.

### DETAILED DESCRIPTION OF THE INVENTION

The present invention is applicable to all generators which may be modelled by a voltage-limited current source, i.e., the electrical voltage at its terminals decreases when the electrical current supplied to its load increases. Under these assumptions, when, the electrical energy supplied by the solar panel is transferred to the converter's inductor, by placing this component parallel to the generator output (switch SW1 in FIG. 1), the solar panel output decreases because the inductor represents a low impedance load, almost a short-circuit. This voltage fall becomes the main reason for the switch-off of the controller, which is responsible for the DC-DC conversion process, between the solar panel's output voltage and the rechargeable battery. To prevent the switch-off of the control circuit as a result of insufficient voltage supply to operate, it is a common procedure to limit the input voltage to a safe value, i.e., to V_{LOW} greater than V_{LIM,OFF}, which represents the lower value allowed to operate that results from the short-circuit caused by the inductor. When reaching this lower limit, the controller is switched off, which in turn switches off the switch SW1. The direct consequence is the recovery of the voltage at the solar panel's terminals a voltage-limited current source), being the solar panel once more available for another operating cycle, as soon as it teaches the V_{MPP} value (the voltage at the maximum peak power).

The present invention, as a methodology, allows correlating the number of times that the controller (ON/OFF signal in FIG. 2) switches off per time unit with the solar irradiance that, generates the electrical energy available at the output of the solar panel. Thus, and since in this invention the load of the solar panel is always constant (the inductor), this methodology is not affected by conditions external to the circuit, such as the charge regimen, type of battery and generator operating limits, for example.

Within the remit of the present invention, the circuit in FIG. 1 is a simplified representation of the methodology described. The component responsible for determining the levels between which the controller switches ON and OFF is the comparator 102. It can be powered by the battery itself, or alternatively in any other way, including the solar panel itself. When the voltage at the generator's terminals falls to the lower operating limit (which is achieved by monitoring fraction, βV_{IN}, of the input voltage, V_{IN}), the comparator generates the ON/OFF signal that allows the electronic switch SW1 to be switched off. After the switch turn-off, the voltage rises quickly because the solar panel's load is then disconnected until the voltage has recovered to the upper limit determined by the comparator hysteresis. At this upper limit, represented by the voltage V_{MPP}=V_{REF}+V_{H}/2, the controller is switched on again, and the pulse width will be proportional to the value of the chosen comparators hysteresis. The choice of these trip limit values (which defines the V_{H} hysteresis band) and the definition of the hysteresis reference value (V_{REF}) allow the adjustment of the range of operation of the sensor obtained by the present methodology.

The present methodology thus enables sensorial information to be obtained, related to the magnitude of solar irradiance collected by photovoltaic solar panel, through the average value <ON,OFF> of the pulses generated by the comparator to control the DC-DC converter used to charge the battery.

1. Method for measuring solar irradiance using a photovoltaic panel which simultaneously allows power supplying of electrical and/or electronic equipment of low consumption or whose consumption is compatible with the solar panel, with sensing information about the intensity and magnitude of the incident solar irradiance on the panel, characterised by:
Monitoring the electrical energy transfer between a solar panel and a rechargeable battery using a switched, voltage converter; and
Indicating the magnitude of the solar irradiance collected by the solar panel;
this method is based on the adaptation of a direct-current (DC) to DC voltage boost converter circuit in, order to provide an electrical signal which is correlated to the magnitude of the solar irradiance collected by the solar panel, which is. also used to power supply the voltage converter circuit.

2. Method for measuring solar irradiance using a solar panel in accordance with claim 1, characterised. by the converter circuit monitoring the voltage level at the solar panel's terminals, which, through comparison with a fixed voltage level, is able to generate a signal composed of electrical pulses that reflects the rate of. recovery of this voltage and, consequently, indicate the energy received by the solar panel that is converted in electrical energy.

3. Method for measuring solar irradiance using a photovoltaic panel in accordance with claim 1, characterised by generating an electrical signal that. indicates when the voltage converter circuit has an appropriate input signal for its normal operation. This intermittent indication depends on the amount of energy available at the input that is converted into electrical voltage by means of an input capacitor C1.

4. Device for measuring solar irradiance using a photovoltaic panel, implementing the method defined in claim 1, characterised by including the aforementioned voltage converter circuit essentially composed of a controller ICI, an inductor L, an electronic switch SW1, a diode D and a capacitor C2, which constitutes the solar panel's active load, and by auxiliary electronic circuits that control the intermittent operation of the voltage converter by analysing the input voltage provided by a solar panel.

5. Solar irradiance measuring device using a photovoltaic panel in accordance with claim 4 characterised by incorporating or not the batteries and the photovoltaic solar panel.

6. Device for measuring solar irradiance using a photovoltaic panel, implementing the method defined in claim 2, characterised by including the aforementioned voltage converter circuit essentially composed of a controller ICI, an inductor L, an electronic switch SW1, a diode D and a capacitor C2, which constitutes the solar panel's active load, and by auxiliary electronic circuits that control the intermittent operation of the voltage converter by analysing the input voltage provided by a solar panel.

7. Device for measuring solar irradiance using a photovoltaic panel, implementing the method defined in claim 3, characterised by including the aforementioned voltage converter circuit essentially composed of a controller ICI, an inductor L, an electronic switch SW1, a diode D and a capacitor C2, which constitutes the solar panel's active load, and by auxiliary electronic circuits that control the intermittent operation of the voltage converter by analysing the input voltage provided by a solar panel.

8. Solar irradiance measuring device using a photovoltaic panel in accordance with claim 6 characterised by incorporating or not the batteries and the photovoltaic solar panel.

9. Solar irradiance measuring device using a photovoltaic panel in accordance with claim 7 characterised by incorporating or not the batteries and the photovoltaic solar panel.
